(19) United States
(12) Patent Application Publication
(10) Pub. No.: US 2009/0075060 A1
(43) Pub. Date: Mar. 19, 2009

(54) ADSORPTIVE COATING FORMULATION

(76) Inventors: James R. Miller, Roanoke, VA (US); Thomas M. Sisson, Charleston, SC (US); Edward Donald Tolles, Charleston, SC (US); Harry W. Robertson, IV, Covington, VA (US)

Correspondence Address: MEADWESTVACO CORPORATION;ATTN: IP LEGAL DEPARTMENT, 1021 MAIN CAMPUS DRIVE, RALEIGH, NC, 27606, US

(21) Appl. No.: 12/271,024

(22) Filed: Nov. 14, 2008

Related U.S. Application Data
(63) Continuation-in-part of application No. 11/059,223, filed on Feb. 16, 2005, now abandoned.

(30) Foreign Application Priority Data
Jan. 24, 2006 (TW) 095102544
Feb. 14, 2006 (EP) 06720762.1
Feb. 14, 2006 (JP) 2007-555350
Feb. 14, 2006 (KR) 7017399/2007
Feb. 14, 2006 (US) PCT/US06/05254

(51) Int. Cl. B32B 5/16; C08K 3/04; C09D 7/12; C08L 91/06

(52) U.S. Cl. 428/323; 106/287.35; 524/496; 524/495; 106/15.05; 106/271; 106/287.3; 106/287.1; 106/285; 106/287.24; 106/287.26; 106/287.23

(57) ABSTRACT

A coating formulation is disclosed that is capable of imparting, onto the treated substrate, an excellent adsorption performance, good print appearance, and enhanced rub-off resistance. Furthermore, the disclosed formulation has good ink stability and offers high quality print appearance throughout long printing runs of high speeding printing applications. The formulation comprises an activated carbon having a particle size of less than 1 micron and a binder, wherein an amount of the binder by weight is in a range of about 30 parts to 100 parts per 100 parts of the activated carbon, and the formulation has a dry basis BET Surface Area of greater than 100 m²/g.

This is a continuation-in-part application of co-pending and commonly assigned U.S. patent application Ser. No. 11/059,223 filed Feb. 16, 2005, which is incorporated herein by reference.

### BACKGROUND OF THE DISCLOSURE

Aqueous-based, high quality printing ink formulations commonly contain pigment particles and an appropriate amount of binder. It is important that the ink formulations have good ink stability and provide high quality print appearance throughout long printing runs. These properties are particularly critical for high-speed printing methods, such as gravure, flexography, and ink-jet. Carbon black is widely used as pigment in the printing formulations. Carbon black is typically made by injecting oil into combustion gas flowing through a reactor at about 3000° F. The hydrocarbon is cracked and dehydrogenated to produce agglomerates of nano-scale carbon particles having a quasi-graphitic structure. General printing formulations containing carbon black are disclosed in U.S. Pat. Nos. 5,630,868, 4,530,961, and 5,281,261. Unfortunately, carbon black is relatively non-porous and has small specific surface area. As such, carbon black is not adsorptive and the printing formulation containing carbon black does not have desirable adsorption performance.

Activated carbons have been widely used as adsorbents for vapor-phase and liquid-phase contaminants. Activated carbons have large specific surface area, typically in the range of 500-2500 m²/g. Activated carbon is a microcrystalline, nongraphitic form of carbon that has been processed to increase internal porosity. Activation of the organic raw material is accomplished by one of two distinct processes: (1) chemical activation or (2) thermal activation. The effective porosity of activated carbon produced by thermal activation is the result of gasification of the carbon at relatively high temperatures (after an initial carbonization of the raw material), but the porosity of chemically activated products generally is created by chemical dehydration/condensation reactions occurring at significantly lower temperatures. Activated carbons produced by thermal activation are typically more microporous (i.e., pore size no more than 1.8 nanometers); while carbons produced by chemical activation are typically more mesoporous (i.e., pore size in a range of above 1.8 up to 5 nanometers). Pore size distribution is often a controlling factor in adsorption of liquid and gas-phase contaminants. Commercial activated carbon has been made from material of plant origin, such as hardwood and softwood, corncobs, kelp, coffee beans, rice hulls, fruit pits, nutshells, and wastes such as bagasse and lignin. Activated carbon also has been made from peat, lignite, soft and hard coals, tars and pitches, asphalt, petroleum residues, and carbon black.

There have been reports on the production of aqueous-based coating formulations using activated carbons as adsorbents. Nonetheless, it is still a challenge to achieve an aqueous adsorptive formulation containing activated carbon that has excellent adsorption performance, and yet is suitable for high-speed printing applications. When simply replacing carbon black with activated carbon in a typical printing ink formulation, the resulting printing formulation does not provide property characteristics required for high-speed printing applications, such as ink stable and printing processability. High levels of binders are needed to afford activated carbon-based printing formulation with desired printability characteristics. These binders/dispersions may have low molecular weight such as in the range of 3,000-20,000 Dalton; therefore, they are readily adsorbed into activated carbon. The adsorbed binders could plug pores of the activated carbons, resulting in a reduction of porosity and adsorption performance of the adsorptive printing formulation. It is known that the higher level of binder to activated carbon in the coating formulation, the better a rub-off resistance, but the poorer adsorption performance.

U.S. Pat. No. 6,639,004 teaches a method of producing adsorptive flexible substrates using a two-step coatings process. The substrate is first coated with a coating primer containing less than 50% weight activated carbon by the total weight of the coating. Then, the resulting coated substrate is applied with a second coating containing a carbon/binder weight ratio of up to about 95%. The NUCHAR® activated carbon available from MeadWestvaco Corp. is used as an adsorbent, characterized by its particle size of about 5-40 microns. The two-step coating is required in order to achieve coated substrate with excellent adsorption performance as well as desirable resistance to rub-off of the coating from the coated substrate. In comparison, a coated substrate produced by one-step coating is disclosed. A coating formulation containing 50% weight activated carbon and 50% weight binder is applied onto the similar substrate, and the coated substrate is tested for adsorption capacity and rub-off resistance (i.e., adhesion property) in comparison to those of the two-step coated substrate. Although the single-step and two-step coated substrates have comparable adsorption performance, the single-step coated substrate has substantially inferior rub-off resistance. In fact, the rub-off resistance of the single-step coated substrate is below the level needed for a practical use. Thus, two-step coating process of coating formulations containing different activated carbon to binder ratio is needed to achieve both the desirable rub-off resistance and adsorption performance.

U.S. Pat. Nos. 5,540,916 and 5,693,385 disclose a method of producing a coated paperboard capable of adsorbing odor. The aqueous coating compositions comprise activated carbon particles dispersed in a sodium silicate or polyester binder system. The NUCHAR® activated carbon available from MeadWestvaco Corp. is used in the coating formulation. The coating formulation is applied onto the paperboard using classical coating applications such as an air knife coater, a wire wound rode coater, and a blade coater. The ratio of the sodium silicate or polyester binder to activated carbon in the coating formulation is critical. Unfortunately, in order to achieve the desired adsorption performance and rub-off resistance, the coated adsorptive paperboard must be further coated with a top coat to minimize the rub-off. The disclosed paperboard typically comprises two coating layers: an adsorptive base coat containing activated carbon and a topcoat that prevents rub-off without jeopardizing the adsorption performance.

U.S. Pat. No. 4,677,019 describes a method of producing an adsorptive flexible substrate by spraying a coating formulation onto the substrate. The coating formulation contains binder and activated carbon having a particle size in the range of 0.1 to 50 microns, preferably 1 to 10 microns. The ratio of binder to activated carbon is critical to achieve the necessary adhesion of the coating onto the substrate and the sufficient bonding within the activated carbon coating that minimizes the rub-off of the coating from the coated substrate. The binder component must be below 20% by weight of the activated carbons (i.e., lower than 20 parts of binder per 100 parts of activated carbon).

European Patent Application 0 392 528A2 describes a method of producing a porous sheet-type media by applying onto the substrate, through a dip-and-squeeze process, an aqueous solution containing zeolite odor-adsorbent particles. The zeolites may be natural or synthetic, which typically have particle size in the range of 1-5 microns. One skilled in the arts realizes that the property requirement of the coating formulation for a dip-and-squeeze process is significantly different from that for the high-speeding printing process.

U.S. Patent Application 2004/0121681 discloses a method of producing a coated substrate having activated carbons as adsorbents. The substrate is first coated with a coating formulation containing polymeric material and an activation agent, and then the resulting coated substrate is heated at high temperatures (100° C.-300° C.) to carbonize and activate the coating. In this method, the coating formulation applied onto the substrate contains no activated carbon and therefore, the common problem of poor printability and stability of activated carbon-based formulation is circumvented. However, this process has serious flaw because the substrate must be able to tolerate the high temperature of 100° C.-300° C., which is the activated conditions needed to obtain activated carbon.

Accordingly, there is a need for an adsorptive printing formulation containing activated carbon that may be applied as a single coat onto the substrate to impart excellent adsorption performance, yet provide good rub-off resistance. Furthermore, it is desirable that such adsorptive formulation has good ink stability over time and offers high quality print appearance throughout long printing runs of high speeding printing applications.

### SUMMARY OF THE DISCLOSURE

The present disclosure relates to a coating formulation capable of imparting, onto the treated substrate, an excellent adsorption performance, good processability, and enhanced rub-off resistance. Furthermore, the disclosed formulation has good ink stability and offers high quality print appearance throughout long printing runs of high speeding printing applications. The disclosed formulation comprises an activated carbon having a particle size of less than 1 micron and a binder, wherein an amount of the binder by weight is in a range of about 30-100 parts per 100 parts of the activated carbon, and the formulation has a dry basis BET Surface Area of greater than 100 m²/g.

### BRIEF DESCRIPTION OF DRAWING

FIG. 1 is a graph showing the comparative DMDS adsorption capacity as a function of BET surface area of three dried adsorptive coatings that have different adsorbents: carbon black, activated carbon obtained through chemical activation process, and activated carbon obtained through thermal activation process.

### DETAILED DESCRIPTION OF THE DISCLOSURE

The present disclosures now will be described more fully hereinafter, but not all embodiments of the disclosure are necessarily shown. While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof.

The adsorptive coating formulation of the present disclosure comprises a binder and activated carbon having a mean particle size of less than 1 micron, wherein an amount of the binder by weight is in a range of about 30-100 parts per 100 parts of the activated carbon, and the formulation has a dry basis BET Surface Area of greater than 100 m²/g. In one embodiment of the present disclosure, the amount of the binder by weight is in a range of about 40-100 parts per 100 parts of the activated carbon. The coating formulation may have solids content in a range of about 25% to about 45%.

The suitable activated carbons for the present disclosure may be produced through several activation processes. These include, but not limited to, thermal activated and chemical activation processes. For thermal activation, the activating agents may include, but not limited to, steam, oxygen, and carbon dioxide. In one embodiment of the disclosure, the activated carbon is produced through a thermal activated process using stream. For chemical activation, the activating agents may include, but are not limited to, alkali metal hydroxides, carbonates, sulfides, and sulfates; alkaline earth carbonates, chlorides, sulfates, and phosphates; phosphoric acid; polyphosphoric acid; pyrophosphoric acid; zinc chloride; sulfuric acid; and oleum. In one embodiment of the disclosure, the activated carbon is produced through a chemical activated process using phosphoric acid. Yet, in one embodiment of the disclosure, the activated carbon is produced through a chemical activated process using zinc chloride. Any known sources of activated carbon may be used in the present disclosure. Examples of these sources include, but are not limited to, wood, coal, cotton linters, peat, coconut, lignite, carbohydrates, petroleum pitch, petroleum coke, coal tar pitch, corncobs, bagasse, kelp, coffee beans, rice hulls, fruit pits, nut shells, nut pits, sawdust, wood flour, carbon black, graphite, tars, pitches, asphalt, petroleum residues, synthetic polymer, natural polymer, and combinations thereof. Several forms of activated carbon may be used in the present disclosure. Examples include, but are not limited to, powder, granular, and pelletized carbon. The powdered form requires shorter milling time to achieve sub-micron particle size.

Example of suitable thermally activated carbons suitable for the present disclosure include, but are not limited to, TAC-600 wood-based activated carbon available from MeadWestvaco Corp. in powdered form; PW-2 coconut-based activated carbon available from Pica in powdered form; and CPG coal-based carbon available from Calgon in granular form, but ground to a powder for the present disclosure.

Examples of suitable chemically-activated carbons for the present disclosure include, but are not limited to, NUCHAR® SA-20, SA-400, TC-400, SA-1500, and RGC, which are available from MeadWestvaco in powder form.

A variety of polymers may be used as the binder in the present disclosure. These polymers may be derived from monomers selected from a group consisting of acrylic acid, methacrylic acid, methyl methacrylate, ethyl methacrylate, styrene, n-propyl methacrylate, n-butyl methacrylate, isopropyl methacrylate, isobutyl methacrylate, n-amyl methacrylate, n-hexyl methacrylate, isoamyl methacrylate, 2-hydroxylethyl methacrylate, 2-hydroxypropyl methacrylate, N,N-dimethylaminoethyl methacrylate, N,N-diethylaminoethyl methacrylate, t-butylaminoethyl methacrylate, 2-sulfoethyl methacrylate, trifluoroethyl methacrylate, glycidyl methacrylate, benzyl methacrylate, allyl methacrylate, 2-n-butoxyethyl methacrylate, 2-chloroethyl methacrylate, sec-butyl-methacrylate, tert-butyl methacrylate, 2-ethylbutyl methacrylate, cinnamyl methacrylate, crotyl methacrylate, cyclohexyl methacrylate, cyclopentyl methacrylate, 2-ethoxyethyl methacrylate, furfuryl methacrylate, hexafluoroisopropyl methacrylate, methallyl methacrylate, 3-methoxybutyl methacrylate, 2-methoxybutyl methacrylate, 2-nitro-2 methylpropyl methacrylate, n-octylmethacrylate, 2-ethylhexyl methacrylate, 2-phenoxyethyl methacrylate, 2-phenylethyl methacrylate, phenyl methacrylate, propargyl methacrylate, tetrahydrofurfuryl methacrylate, tetrahydropyranyl methacrylate, methyl acrylate, ethyl acrylate, n-propyl acrylate, isopropyl acrylate, n-butyl acrylate, n-decyl acrylate, 2-ethylhexyl acrylate, salts of methacrylic acid, methacrylonitrile, methacrylamide, N-methylmethacrylamide, N-ethylmethacrylamide, N,N-diethymethacrylamide, N,N-dimethylmethacrylamide, N-phenyl-methacrylamide, methacrolein, salts of acrylic acid, acrylonitrile, acrylamide, methyl alpha-chloroacrylate, methyl 2-cyanoacrylate, N-ethylacrylamide, N,N-diethylacrylamide acrolein, vinyl acetate, vinyl chloride, vinyl pyridine, vinyl pyrollidone, sodium crotonate, methyl crotonate, crotonic acid, maleic anhydride, and combinations thereof. The binders used in the present disclosure may have a glass transition temperature is in the range of about −40° C. to about 100° C. Additionally, the binder suitable for use in the present disclosure may include polymers having a molecular weight in a range of 3,000-20,000 Daltons, which are commonly known as “dispersion.” Examples of these dispersions include, but are not limited to, vinylic emulsion; colloidal copolymers; polymeric surfactant; styrene-acrylic acid copolymer; and combinations thereof.

When desired, the disclosed adsorptive coating formulation may include additives typically used in coating or printing ink formulation. These include, but are not limited to, defoamer, wax, surfactant, solvent, coalescing solvent, dispersant, ammonium hydroxide, rheology modifier, biocide, plasticizer, buffer, and combinations thereof. In one embodiment, the disclosed formulation includes about 4% to about 12% weight of wax based on the total weight of the coating, and from about 0.05% to about 1% weight of defoamer based on the total weight of the formulation. Examples of suitable defoamers include, but are not limited to, aromatic petroleum-base materials, aliphatic petroleum-base materials, aliphatic oils, mineral oils, silicone, and combinations thereof. Either synthetic wax or natural wax may be used in the present disclosure. When desired, the disclosed formulation may include from about 0.5% to about 10% weight of solvent based on the total weight of the formulation. Examples of suitable solvents include, but are not limited to, alcohols with one or more hydroxyl groups, glycols with one or more hydroxyl groups, ethers, esters, hydrocarbons, aromatics, mineral spirits, and combinations thereof.

In one embodiment of the present disclosure, the adsorptive coating formulation is produced by combining activated carbon with dispersant and defoamer, then milling the resulting mixture to a sub-micron particle size, and subsequently mixing the resulting particles with wax and binder in amounts sufficient to bind the activated carbon particles to a substrate and minimize rub-off.

Activated carbon products, such as the NUCHAR® products sold by MeadWestvaco, are milled to a sub-micron particle size, which are dispersible in coatings, inks, or the like and are suitable for application to a variety of substrates such as polyolefin flexible films. The benefit of having sub-micron particles is to improve the kinetics of adsorption, the graphic appearance of the coated product, and the runnability of conventional high-speed printing methods such as gravure, flexography, and ink-jet. A variety of substrates may be used. These include, but are not limited to, synthetic films, paperboard, paper, coated paper, laminated paper, cellulosic and synthetic-based non-wovens, metals, ceramics, rigid plastics, and combinations thereof. In one embodiment of the present disclosure, polyester film is used as substrate. Yet in one embodiment of the present disclosure, polyolefin film is used as substrate. The disclosed adsorptive coating formulation may be applied onto substrate using any known coating or printing application. These include, but are not limited to, high-speed printing such as gravure, flexography, and ink jet; air knife coatings; wire round rod coating; blade coating; spray coating; and dip coating. After application of the adsorptive coating onto the substrate, the coated product can be used “as is” or converted into packages, liner elements, trash bags, pouches, structured media, monolithic structures, building materials or the like suitable for use in many different applications where adsorption of vapor phase contaminants is desired. These applications can include odor adsorption, adsorption of harmful air-borne contaminants which may or may not be odiferous, and recovery of valuable vapor-phase compounds which may or may not be odiferous. Liquid-phase applications can also be contemplated such as the removal of contaminants from aqueous or organic streams, decolorization of colored streams, and recovery of valuable compounds from aqueous or organic streams.

### EXPERIMENTS

### Experiment 1

### Different Types of Carbons

Several commercial available activated carbons were studied, including NUCHAR® activated carbon products from MeadWestvaco. Carbon Black Pearls 410 commercially available from Cabot was used in the comparative coating formulation. The binder used was JONREZ® I-988 emulsion, which is a styrene-acrylate copolymer at 38% solids produced by MeadWestvaco; and JONREZ® H-2702 dispersion, which is a styrene acrylic acid copolymer produced by MeadWestvaco. JONREZ® W-2320, which is a polyethylene wax emulsion at 25% solids produced by MeadWestvaco, was used as wax. FOAMBLAST® 370, which is an organic petroleum derivative produced by Lubrizol at 20% solids was used as defoamer.

TABLE I shows the percentages of raw materials found in the adsorptive coating formulation and a typical carbon black printing

TABLE I

| | Amount in Disclosed | | Amount in Typical | |
|---|---|---|---|---|
| | Adsorptive | | Carbon Black | |
| | Coating Formulation | | Printing Ink Formulation | |
| | (% | | (% | |
| Raw Material | wet basis) | (% dry basis) | wet basis) | (% dry basis) |
| Carbon | 23.2 | 62.8 | 15.0 | 48.9 |
| (activated carbon or | | | | |
| carbon | | | | |
| black) | | | | |
| Water | 43 | 0 | 28.0 | 0 |
| Binder | 14.5 | 27.1 | 47.0 | 46.2 |
| Defoamer | 0.3 | 0.2 | 0.3 | 0.06 |
| Ammonium | 4.2 | 0 | 3.7 | 0 |
| Hydroxide | | | | |
| Wax | 14.8 | 10.0 | 6.0 | 4.9 |

To produce the adsorptive coating formulation, the raw materials were combined in a blender available from Waring and blended for 20 minutes. In this step, physical blending took place, and very little particle size reduction occurred. The blended materials were transferred to a Szegvari Attritor System ball mill, using 1.0-1.6 mm zirconium beads, where the carbon was milled for 12 to 30 hours to obtain particle sizes less than 1 micron. Following milling, the particle size distribution was measured using Beckman Coulter N4 Plus Submicron Particle Size Analyzer to ensure that its median size was less than 1 micron.

The viscosities of the coating formulations were measured using #2 Zahn Cup. Viscosities of the formulations ranged from 18-28 seconds. Drawdowns were made with a K-Coater (RK Print-Coat Instruments, Ltd) using a #1 bar (6 micron thick wet coating) on glass plates and dried with heated air. Drawdowns were made on glass so that the dried coating could be removed and tested for adsorption capacity and surface area. The targeted coat weight of the dried draw down was 4-10 g/m². This is a reasonable coat weight for most application.

The dried coatings were removed from the glass plates and measured for BET surface area using a Micromeritics ASAP 2010 Surface Area and Porosimetry System. The BET surface area of the loose carbon powder was also measured and recorded. By knowing the surface area of the dried coating and the loose carbon powder, and estimating a carbon content in the dried coating, the fraction of surface area remaining in the carbon (F) was calculated by the following equation:

$$Fraction of Surface Area Remaining in Carbon ( F ) = \frac{Surface Area of Dried Coating}{0.628 * Surface Area of Loose Powder}$$

The “0.628” factor is based on the estimate that the dried coating contains 62.8% carbon.

Adsorption capacity of the dried coatings removed from the glass plates was measured using a common odorant, Dimethyldisulfide (DMDS). DMDS is an odor component of garlic, human waste, and some industrial process such as the Kraft pulping process. DMDS is extremely odorous, having an odor threshold of 0.001 ppm. This is much lower than other common odorants, such as ammonia which has an odor threshold of 10 ppm. Adsorption capacities of the various coating formulations were measured by headspace analysis using a Hewlett Packard 5890 gas chromatograph with a Perkin Elmer HS40 headspace sampler. Quantities of the dried coating film ranging from 10 to 160 mg were introduced into a series of headspace vials. Sufficient DMDS liquid was then injected into the vials to produce a vapor phase concentration of 2.5% by volume in the absence of any adsorbent. GC analysis was conducted to determine the concentration of DMDS in the vial after equilibration with the adsorbent coating. The amount adsorbed was determined by difference, and the amount adsorbed per gram of coating was calculated.

TABLE II

| | BET Surface Area | | | | |
|---|---|---|---|---|---|
| | Loose | | | Median Particle | Adsorption Capacity of |
| | Carbon | | | Diameter of | DMDS at 1000 ppm |
| | Powder | Dried Coating | Fraction of Surface | Coating | DMDS (g DMDS/g |
| Carbon Type | (m²/g) | (m²/g) | Area Remaining = F | (microns) | Dried Coating) |
| NUCHAR ® SA-1500 | 2219 | 780 | 0.56 | 0.405 | 0.296 |
| NUCHAR ® RGC | 1463 | 500 | 0.54 | 0.825 | 0.198 |
| NUCHAR ® TC-400 | 1659 | 475 | 0.45 | 0.475 | 0.190 |
| NUCHAR ® SA-20 | 1633 | 461 | 0.45 | 0.320 | 0.190 |
| NUCHAR ® SA-400 | 1604 | 367 | 0.37 | 0.140 | 0.161 |
| PW-2 | 1140 | 191 | 0.27 | 0.750 | 0.141 |
| CPG | 891 | 127 | 0.23 | 0.850 | 0.125 |
| TAC-600 | 586 | 7 | 0.02 | 0.450 | 0.079 |
| Black Pearls | | 14 | | 0.190 | 0.010 |
| (Carbon Black) | | | | | |

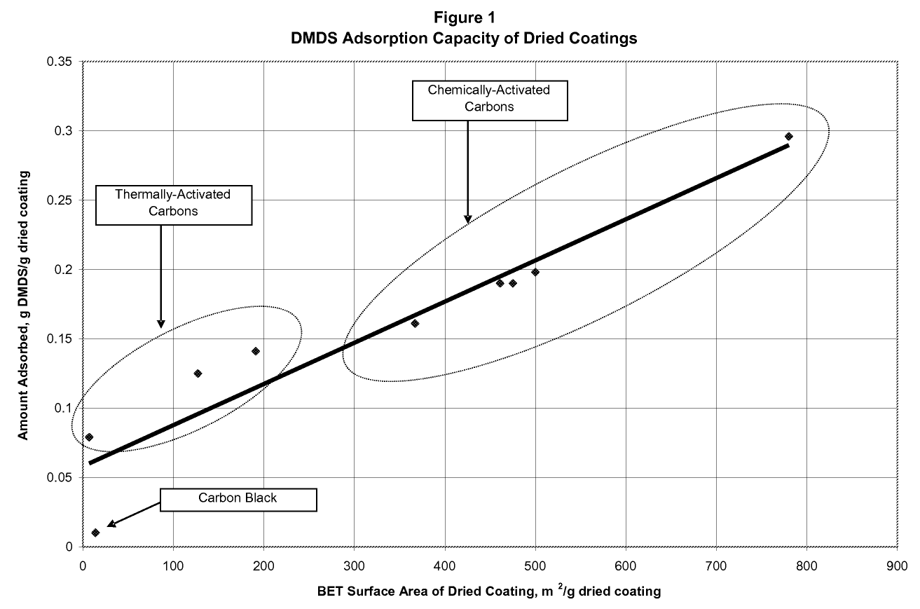

TABLE II shows that the properties of the comparative adsorptive coatings. FIG. 1 is a graphic depiction of the data exhibited in TABLE II. The dried coatings from the disclosed coating formulation containing activated carbons have significantly higher surface and hence adsorption capacity, compared to the coating from the comparative formulation containing carbon black. The adsorption capacity correlates strongly with the surface area of the loose carbon powder and the surface area of the dried carbon coating over a wide range of activated carbon types. This is surprising given the great difference in pore size distributions of the different carbon types. Furthermore, as surface area of the loose carbon powder or dried carbon coating increases, the fraction of surface area remaining in the carbon increases. Based on these data, a reasonable lower limit for F is 0.20, which is equivalent to a lower limit of BET surface area in the dried coating of approximately 100 m²/g. This is further equivalent to a DMDS adsorption capacity of 0.1 g/g dried coating, which is reasonable for vapor-phase adsorption.

### Experiment 2

### Different Formulations

(1) Adsorption Performance Study

To study the effect of formulation chemistry, the coating formulation disclosed in U.S. Pat. No. 6,639,004 was used as a comparison to the coating formulation of the present disclosure. The formulation of '004 patent contains 100 weight parts of binder per 100 parts of activated carbon (i.e., the sample 50% Carbon/50% Binder shown in TABLE I of the '004 patent). The binder was JONREZ® E-2064 emulsion from MeadWestvaco (50% solids). NUCHAR® TC-400 activated carbon from MeadWestvaco was used as the activated carbon and milled to a submicron median particle size of about 0.8 microns. The resulting submicron activated carbon and JONREZ® E-2064 binder were then used to produce the formulation of '004. The submicron adsorptive coating formulation of the present disclosure was produced as shown in the EXPERIMENT 1, with NUCHAR® TC-400. The main difference in these formulations is the presence of the low molecular weight components, such as dispersion and defoamer, in the present disclosure. These components were added to improve the stability of the present disclosure.

The BET surface area and DMDS adsorption capacity of the dried coating from the disclosed adsorptive formulation were measured and compared to those of the dried coating from the formulation of '004 patent. TABLE III shows that the properties of the comparative adsorptive coatings. The coating from the adsorptive formulation of the present disclosure has substantially higher surface area and DMDS adsorption capacity, compared to that from the formulation of '004 patent. This is very surprising, since both formulations had about the same activated carbon content and the present disclosure contained low molecular weight components that could have occluded porosity, resulting in a reduction of surface area and adsorption capacity.

TABLE III

| | | Adsorption |
|---|---|---|
| | | Capacity |
| | BET Surface Area | of DMDS* |
| | of Dried Coating | (g DMDS/g Dried |
| Formulation | (m²/g) | Coating) |
| Formulation of the | 475 | 0.190 |
| Present Disclosure | | |
| Formulation of | 22 | 0.145 |
| U.S. Pat. No. | | |
| 6,639,004 | | |

*at 1000 ppm DMDS

(2) Stability Study

The stability of the adsorptive coatings formulation over time is critical for practical use, especially for the printing applications. The stability of the adsorptive coating formulation of the present disclosure was studied and compared to that of the coating formulation disclosed in the '004 patent. The color index measurement was used to determine the stability of the adsorptive coating formulations. The better stability of the formulation, the less change in the color index over time. A constant color value indicates the coating is stable, while a changing value indicates the coating is not stable and would require additional attention during the printing process.

The drawdown of each coating formulation was made and measured for the initial color index. Then, both coating formulations were kept at the same conditions, and the samples of each formulation were taken at different time intervals. The drawdowns were made of each sample and measured for color index.

The drawdowns were made on standard sheets of C1S bleached board using a K-Coater (RK Print-Coat Instruments, Ltd). The coating thickness was controlled by selection of different bars. Both #3 and #5 bars were used. The #3 bar gave a wet thickness of 24 microns, and the #5 bar gave a wet thickness of 50 microns. Once the coating was applied to the board, it was quickly dried with a handheld heated drier.

The color index was determined using a Hunter Lab DP25-9000 Colorimeter. Since the coatings are essentially black, the “L” color value was used to make comparisons. An L value of 0 is black and a value of 100 is white.

For each adsorptive coating formulation, the formulation was well mixed in a 1 liter container using a magnetic stir bar for an hour. Immediately after mixing, four 4″×4 drawdowns were made with each bar for each coating and dried. The L value was measured in 4 positions on each drawdown board. An average L value was determined from the 16 data points for each coating formulation and each bar combination. This measured number was the L value at time=0. After obtaining the L value at time=0, each coating was allowed to sit undisturbed for 192 hours (8 days). Without any stirring, new drawdowns were made with each bar for each coating formulations. A new set of L values were measured and averaged. These are L values at the time=192 hrs.

TABLE IV

| Coating | Coating |
|---|---|
| Formulation of | Formulation of |
| the Present | U.S. Pat. No. |
| Disclosure | 6,639,004 |

| Drawdown | Time = | Time = | Time = | Time = |
|---|---|---|---|---|
| Bar | 0 hrs | 192 hrs | 0 hrs | 192 hrs |
| #3 Bar | 15.3 | 15.5 | 19.8 | 62.6 |
| #5 Bar | 14.9 | 15.1 | 18.0 | 46.6 |

The average L values are shown in TABLE IV. The L values of the adsorptive coating formulation of the present disclosure remained essentially the same after 192 hrs. On the other hand, the L values for the formulation of '004 patent at 192 hrs changed significantly from the initial L value. Therefore, the adsorptive coating formulation of the present disclosure is much more stable than the adsorptive coating formulation of the '004 patent

U.S. Pat. Nos. 6,639,004 and 4,677,019 disclose the need to limit the amount of binder in the coating formulations to be no more than 20% (based on the weight of activated carbon) in order to achieve good adsorption performance. In contrast, the coating formulation of the present disclosure achieves excellent surface area and adsorption performance at higher binder levels (30%-100%). In addition, the coating formulation of the present disclosure provides improved processability and enhanced rub-off resistance. As a result, the disclosed adsorptive formulation may be applied as a single coat or as a part of a multi-step coating process onto the substrate to impart excellent adsorption performance, yet provide good rub-off resistance. Furthermore, the disclosed formulation has good ink stability and offers high quality print appearance throughout long printing runs of high speeding printing

While the invention has been described by reference to various specific embodiments, it should be understood that numerous changes may be made within the spirit and scope of the inventive concepts described. It is intended that the invention not be limited to the described embodiments, but will have full scope defined by the language of the following claims.

We claim:

1. An adsorptive coating formulation, comprising activated carbon characterized by a particle size of less than 1 micron and a binder, wherein an amount of the binder by weight is in a range of about 30 parts to 100 parts per 100 parts of the activated carbon, and the formulation has a dry basis BET Surface Area of greater than 100 m²/g.

2. The formulation of claim 1, wherein an amount of the binder by weight is in a range of about 40 parts to 100 parts per 100 parts of the activated carbon.

3. The formulation of claim 1, characterized by a solids content in the range of from about 25% to about 45%.

4. The formulation of claim 1, wherein a source of the activated carbon includes a member selected from the group consisting of wood, coal, cotton linters, peat, coconut, lignite, carbohydrates, petroleum pitch, petroleum coke, coal tar pitch, corncobs, bagasse, kelp, coffee beans, rice hulls, fruit pits, nut shells, nut pits, sawdust, wood flour, carbon black, graphite, tars, pitches, asphalt, petroleum residues, synthetic polymer, natural polymer, and combinations thereof.

5. The formulation of claim 1, wherein the binder is a polymer derived from monomers comprising a member selected from the group consisting of vinylic emulsion and colloidal copolymers with monomer compositions selected from a group consisting of acrylic acid, methacrylic acid, methyl methacrylate, ethyl methacrylate, styrene, n-propyl methacrylate, n-butyl methacrylate, isopropyl methacrylate, isobutyl methacrylate, n-amyl methacrylate, n-hexyl methacrylate, isoamyl methacrylate, 2-hydroxylethyl methacrylate, 2-hydroxypropyl methacrylate, N,N-dimethylaminoethyl methacrylate, N,N-diethylaminoethyl methacrylate, t-butylaminoethyl methacrylate, 2-sulfoethyl methacrylate, trifluoroethyl methacrylate, glycidyl methacrylate, benzyl methacrylate, allyl methacrylate, 2-n-butoxyethyl methacrylate, 2-chloroethyl methacrylate, sec-butyl-methacrylate, tert-butyl methacrylate, 2-ethylbutyl methacrylate, cinnamyl methacrylate, crotyl methacrylate, cyclohexyl methacrylate, cyclopentyl methacrylate, 2-ethoxyethyl methacrylate, furfuryl methacrylate, hexafluoroisopropyl methacrylate, methallyl methacrylate, 3-methoxybutyl methacrylate, 2-methoxybutyl methacrylate, 2-nitro-2 methylpropyl methacrylate, n-octylmethacrylate, 2-ethylhexyl methacrylate, 2-phenoxyethyl methacrylate, 2-phenylethyl methacrylate, phenyl methacrylate, propargyl methacrylate, tetrahydrofurfuryl methacrylate, tetrahydropyranyl methacrylate, methyl acrylate, ethyl acrylate, n-propyl acrylate, isopropyl acrylate, n-butyl acrylate, n-decyl acrylate, 2-ethylhexyl acrylate, salts of methacrylic acid, methacrylonitrile, methacrylamide, N-methylmethacrylamide, N-ethylmethacrylamide, N,N-diethymethacrylamide, N,N-dimethylmethacrylamide, N-phenyl-methacrylamide, methacrolein, salts of acrylic acid, acrylonitrile, acrylamide, methyl alpha-chloroacrylate, methyl 2-cyanoacrylate, N-ethylacrylamide, N,N-diethylacrylamide acrolein, vinyl acetate, vinyl chloride, vinyl pyridine, vinyl pyrollidone, sodium crotonate, methyl crotonate, crotonic acid, maleic anhydride, and combinations thereof.

6. The formulation of claim 1, wherein the glass transition temperature of the binder is in the range of about −40° C. to about 100° C.

7. The formulation of claim 1, wherein the binder includes a dispersion having a molecular weight in a range of 3,000-20,000 Daltons.

8. The formulation of claim 7, wherein the dispersion comprises a polymer selected from the group consisting of vinylic emulsion, colloidal copolymers, polymeric surfactant, styrene-acrylic acid copolymer, and combinations thereof.

9. The formulation of claim 1, further comprising from about 4% to about 12% weight of wax based on the total weight of the coating, and from about 0.05% to about 1% weight of defoamer based on the total weight of the formulation.

10. The formulation of claim 1, further comprising an additive selected from the group consisting of defoamer, wax, surfactant, solvent, coalescing solvent, dispersant, ammonium hydroxide, rheology modifier, biocide, plasticizer, buffer, and combinations thereof.

11. The formulation of claim 10, wherein the defoamer comprises a member selected from the group consisting of aromatic petroleum-base materials, aliphatic petroleum-base materials, aliphatic oils, mineral oils, silicone, and combinations thereof.

12. The formulation of claim 1, further comprising from about 0.5% to about 10% weight of solvent based on the total weight of the formulation.

13. The formulation of claim 12, wherein the solvent comprises a member selected from the group consisting of alcohols with one or more hydroxyl groups, glycols with one or more hydroxyl groups, ethers, esters, hydrocarbons, aromatics, mineral spirits, and combinations thereof.

14. An adsorptive article, comprising a substrate and the coating formulation of claim 1.

15. The adsorptive article of claim 14, wherein the substrate comprises a member selected from the group consisting of synthetic films, paperboard, paper, coated paper, laminated paper, cellulosic and synthetic-based non-wovens, metals, ceramics, rigid plastics, and combinations thereof.

16. The adsorptive article of claim 15, wherein the synthetic films comprises a member selected from the group consisting of polyester films, polyolefin films, and combinations thereof.
